(19) United States
(12) Patent Application Publication
(10) Pub. No.: US 2022/0221114 A1
(43) Pub. Date: Jul. 14, 2022

(54) GROUND-INSERTED DECORATIVE LAMP STRING

(71) Applicant: Xiaoxing JIANG, Zhejiang (CN)

(72) Inventor: Xiaoxing JIANG, Zhejiang (CN)

(21) Appl. No.: 17/349,949

(22) Filed: Jun. 17, 2021

(30) Foreign Application Priority Data
Jan. 14, 2021 (CN) 202120103155.3

(51) Int. Cl. F21K 9/66; F21V 1/00; F21V 17/06; F21V 21/08; F21V 23/00; F21S 4/28

(52) U.S. Cl. CPC F21K 9/66; F21V 1/00; F21V 17/06; F21Y 2115/10; F21V 23/002; F21S 4/28; F21V 21/0824

(57) ABSTRACT

A ground-inserted decorative lamp string includes at least two decorative lamp bodies, each of which includes a decorative lamp main body and a ground insert. The decorative lamp main body includes a decorative lampshade, a lamp pole and an LED lamp string. The decorative lampshade is internally provided with a lamp bead accommodating cavity, and the lamp bead accommodating cavity penetrates through an inner cavity of the lamp pole. An upper end of the lamp pole is used to be cooperatively installed with the decorative lampshade, and a lower end of the lamp pole is used to be cooperatively installed with the ground insert, and the LED lamp string extends into the inner cavity of the lamp string, such that at least one LED lamp bead extends through the upper end of the inner cavity of the lamp pole and is located in the lamp bead accommodating cavity.

### CROSS-REFERENCE TO RELATED APPLICATION

This application claims the priority benefit of China application serial no. 202120103155.3, filed on Jan. 14, 2021. The entirety of the above-mentioned patent application is hereby incorporated by reference herein and made a part of this specification.

### BACKGROUND

### Technical Field

The present invention relates to the technical field of decorative lamp strings, in particular to a ground-inserted decorative lamp string.

### Description of Related Art

A ground-inserted lamp, an illuminating facility inserted into the ground, illuminates and decorates the ground and sceneries around, such that the sceneries are more beautiful.

A patent with the publication number CN210951100U discloses a solar ground inserting lamp. The solar ground inserting lamp includes a mounting column, a light emitting source, an energy supply device and a ground insert. A mounting seat is connected to the top of the mounting column in a sleeving manner, the light emitting source is mounted in the mounting seat, the light emitting source is an LED lamp string, the energy supply device is arranged in the middle portion of the mounting column, the energy supply device is a solar photovoltaic panel and a storage battery, the solar photovoltaic panel is arranged right above, the storage battery is arranged below the solar photovoltaic panel and is electrically connected to the solar photovoltaic panel, a control unit is arranged at the bottom of the storage battery and is used for controlling communication between the light emitting source and the storage battery, and the ground insert is mounted and connected at the bottom of the mounting column in a sleeving manner.

A patent with the publication number CN202195396U discloses a battery pack tree lamp reasonable in structural design, attractive in appear and long in service life. The battery pack tree lamp includes a trunk, a branch and a lamp string. The branch is arranged on the trunk. The battery pack tree lamp further includes a circuit box, a circuit board and a battery pack. The circuit box is arranged on the trunk, the battery pack and the circuit board are arranged in the circuit box, the battery pack is electrically connected to the circuit board, the branch is of a hollow structure, the lamp string is arranged in the branch and includes a lead and an illuminant, and the illuminant is electrically connected to an output end of the circuit board via a lead.

However, an existing ground inserting lamp which is usually of a single lamp body structure is complex to model the lamp body, large in production cost and large in size and cannot form good light decoration for the large region.

### SUMMARY

The present invention aims to provide a ground-inserted decorative lamp string which is used for solving the technical problems, can form a lamp string form and has the characteristics of being small and exquisite in structure, convenient to mount and use and good in decorative effect.

In order to solve the technical problems, the present invention adopts a technical scheme as follows.

A ground-inserted decorative lamp string, includes at least two decorative lamp bodies. Each of the decorative lamp bodies includes a decorative lamp main body and a ground insert. The decorative lamp main body includes a decorative lampshade, a lamp pole and an LED lamp string. The decorative lampshade is internally provided with a lamp bead accommodating cavity, and the lamp bead accommodating cavity penetrates through an inner cavity of the lamp pole. An upper end of the lamp pole is used to be cooperatively installed with the decorative lampshade, and a lower end of the lamp pole is used to be cooperatively installed with the ground insert, and the LED lamp string extends into the inner cavity of the lamp string, such that at least one LED lamp bead extends through the upper end of the inner cavity of the lamp pole and is located in the lamp bead accommodating cavity.

A socket end is arranged in an upper portion of the ground insert, the socket end is used to be inserted into the lower end of the lamp pole to complete fixation, and the socket end is provided with a lamp string slot.

A number of the decorative lamp bodies is three or more, and adjacent two of the decorative lamp bodies are in electrical connection via a lamp string lead.

The ground-inserted decorative lamp string further includes a controller, and the controller is in conductive connection with adjacent one of the decorative lamp bodies via the lamp string lead.

The ground-inserted decorative lamp string further includes a solar power apparatus. A clamping piece is arranged at one end of the solar power apparatus, and the clamping piece can be clamped on the lamp pole or the ground insert.

A joint of the lamp pole and the decorative lampshade is provided with an open slot, the open slot is provided with a decorative lamp string strip extending in a direction toward the ground insert, and the decorative lamp string strip is spirally coiled on an exterior of the lamp pole or floatingly circles the exterior of the lamp pole.

The decorative lampshade is made of a transparent material.

The decorative lampshade is in a shape of any one or more of snow, star, plant or animal.

The lamp pole is made of a transparent material and the LED lamp string in the inner cavity of the lamp pole comprises the at least one LED lamp bead.

The lamp pole is made of a non-transparent material and the LED lamp string in the inner cavity of the lamp pole is the lamp string lead.

Compared with the prior art, the present invention has the prominent advantages and effects that the present invention adopts the design of combining the lamp string with the ground insert through optimization design, to simplify the installation structure of the ground-inserted lamp, such that the ground-inserted decorative lamp string becomes smaller and more exquisite, has diverse forms, and is convenient for installation and use, thereby achieving lamplight decoration in a large region depending on requirements.

Features of the present invention can be understood clear with reference to detailed description of drawings and preferred embodiments below.

### BRIEF DESCRIPTION OF THE DRAWINGS

FIG. 1 is an exploded schematic diagram of a decorative lamp body of the present invention;

FIG. 2 is a structural schematic diagram of a ground insert of the present invention;

FIG. 3 is a cross-sectional view showing the overall structure of the present invention;

FIG. 4 is a cross-sectional view showing the overall structure of the present invention;

FIG. 5 is an assembled schematic diagram of the decorative lamp body of the present invention;

FIG. 6 is a schematic diagram of mounting of a solar power supply apparatus of the present invention;

FIG. 7 is a first structural schematic diagram of overall mounting according to the present invention.

FIG. 8 is a second structural schematic diagram of overall mounting according to the present invention;

FIG. 9 is a third structural schematic diagram of overall mounting according to the present invention,

### DESCRIPTION OF THE EMBODIMENTS

In order to make the technical means, creative features, achievement goals and effects achieved by the present invention easy to understand, the present invention will be further described below in conjunction with specific illustrations.

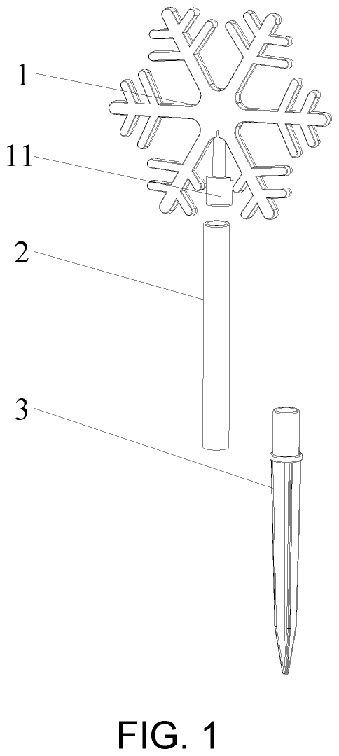

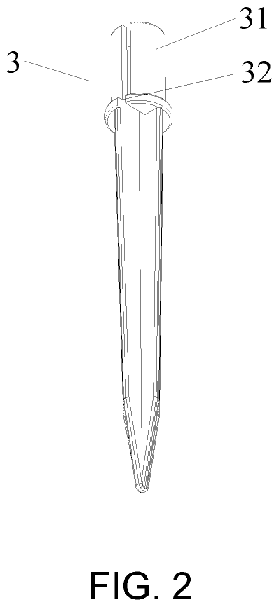

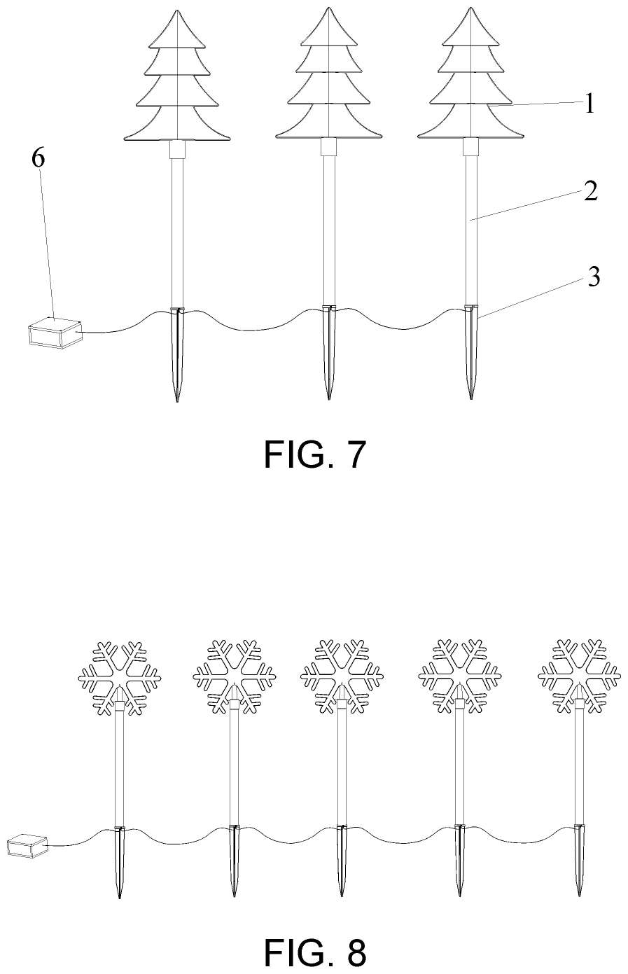

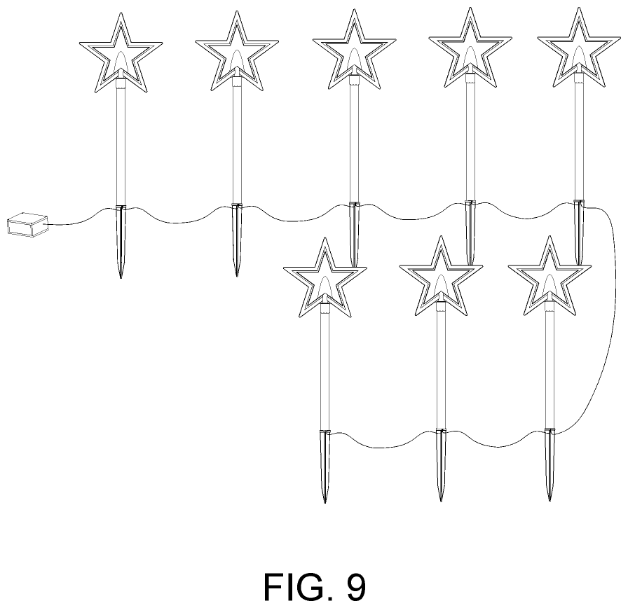

As shown in FIG. 1 to FIG. 9, the present invention provides a ground-inserted decorative lamp string, including at least two decorative lamp bodies. The decorative lamp body includes a decorative lamp main body and a ground insert 3, the ground insert 3 is used for being inserted into the ground and is usually suitable for outdoor regions such as a garden and a lawn, the decorative lamp body is mounted on an upper portion of the ground insert, the ground insert 3 is usually partially or fully inserted into the ground, and the decorative lamp bodies are exposed outside to achieve light decoration.

The decorative lamp main body includes a decorative lampshade 1, a lamp pole 2 and an LED lamp string 4. The decorative lampshade 1 is internally provided with a lamp bead accommodating cavity 12, and the lamp bead accommodating cavity 12 penetrates through an inner cavity of the lamp pole 2. An upper end of the lamp pole 2 is used to be cooperatively installed with the decorative lampshade 1, and a lower end of the lamp pole 2 is used to be cooperatively installed with the ground insert 3. The LED lamp string 4 extends into the inner cavity of the lamp pole 2, and at least one LED lamp bead 41 extends through the upper end of the inner cavity of the lamp pole and is located in the lamp bead accommodating cavity 12. As the LED lamp string 4 extends into the lamp pole 2, and the LED lamp bead 41 is located in the lamp bead accommodating cavity 12 in the decorative lampshade 1 to form light illumination. In addition, combined with the LED lamp string 4, a plurality of decorative lamp bodies are connected to form the lamp string, such that the lamp string is modeled more attractively and the form of the lamp string is reserved.

The socket end 31 is arranged in an upper portion of the ground insert 3, the socket end 31 is used to be inserted into the lower end of the lamp pole 2 to complete fixation, and the socket end 31 is provided with lamp string slot 32, and the lamp string slot 32 facilitates embedded mounting of the LED lamp string 4.

In one of preferred embodiments, the number of the decorative lamp bodies is three or more, and the adjacent two decorative lamp bodies are in electrical connection via a lamp string lead, preferably. The number of the decorative lamp bodies can be three in a group, four in a group, five in a group, six in a group, seven in a group, eight in a group, nine in a group, ten in a group, eleven in a group, twelve in a group and the like according to client's demands, and the number of the decorative lamp bodies can be still increased according to a service condition.

The ground-inserted decorative lamp string further includes a controller 6. The controller 6 is in conductive connection with one adjacent decorative lamp body via the lamp string lead and the controller 6 is used for achieving light control and power supply control of the

LED lamp string 4. The controller is usually a common LED lamp string controller in the prior art.

The controller 6 is usually a built-in battery pack which supplies a power supply or is connected to a power supply through an electric wire socket.

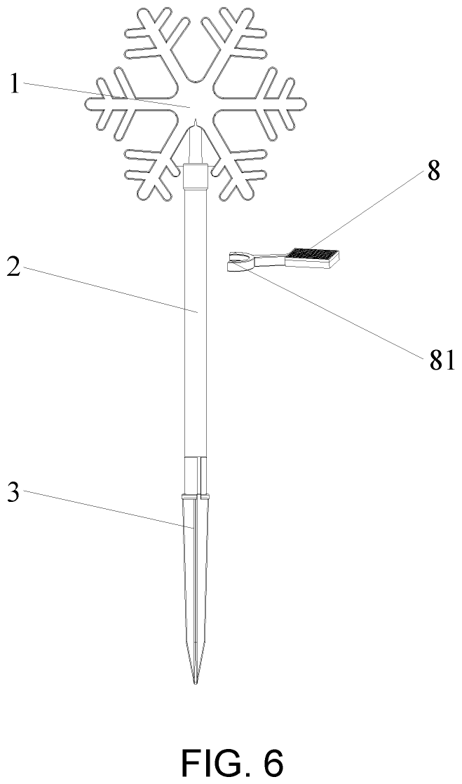

In one of preferred embodiments, as shown in the FIG. 6, the ground-inserted decorative lamp string further includes a solar power supply apparatus 8. A clamping piece 81 is arranged at one end of the solar power supply apparatus 8 and the clamping piece 81 is clamped on the lamp pole 2 or the ground insert 3. The solar power supply apparatus usually includes a solar panel and a built-in storage battery for supply power to the LED lamp string 4 and is usually matched with the controller 6.

Preferably, a lamp pole mounting seat 11 is arranged in the lower portion of the lamp bead accommodating cavity 12, the upper end of the lamp pole 2 is inserted into the lamp pole mounting seat 11, and the inner cavity of the lamp pole 2 penetrates through the lamp bead accommodating cavity 12, such that it is convenient to mount the LED lamp string 4.

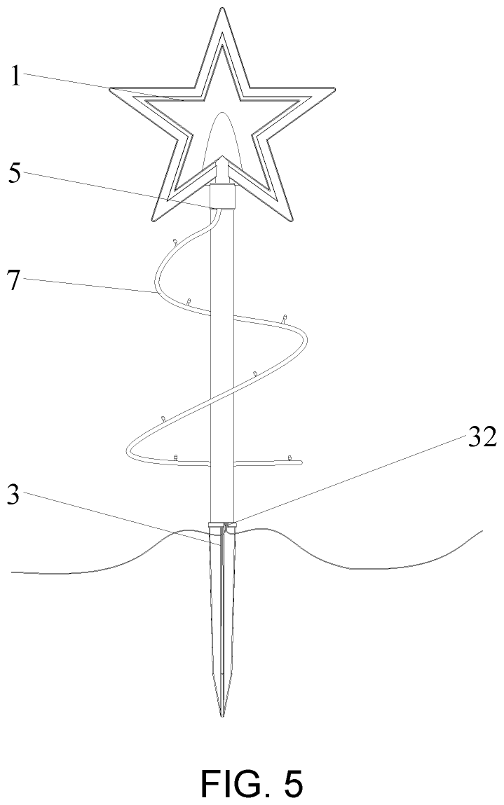

In one of preferred embodiments, as shown in the FIG. 5, the joint of the lamp pole 2 and the decorative lampshade 1 is provided with an open slot 5. The open slot 5 is provided with a decorative lamp string strip 7 extending in a direction toward the ground insert 3, and the decorative lamp string strip 7 is spirally coiled on the exterior of the lamp pole 2 or floatingly circles the exterior of the lamp pole 2. The overall appearance attraction is improved. The decorative lamp string strip 7 is a part of the LED lamp string 4 or is additionally arranged.

Preferably, the decorative lampshade 1 is made of a transparent material.

Preferably, the decorative lampshade 1 is in a shape of any one or more of snow, star, plant or animal, wherein plant can be cactus, flower, pineapple, Christmas tree and the like and animal can be flamingo, snowman, Christmas deer and the like. The decorative lampshade is mainly in a shape of Christmas related article models, for example, angel, Santa Claus, snowman,

Christmas deer, bell and the like and can be further in a shape of Halloween article models, for example, spider, human skeleton, pumpkin lamp and the like.

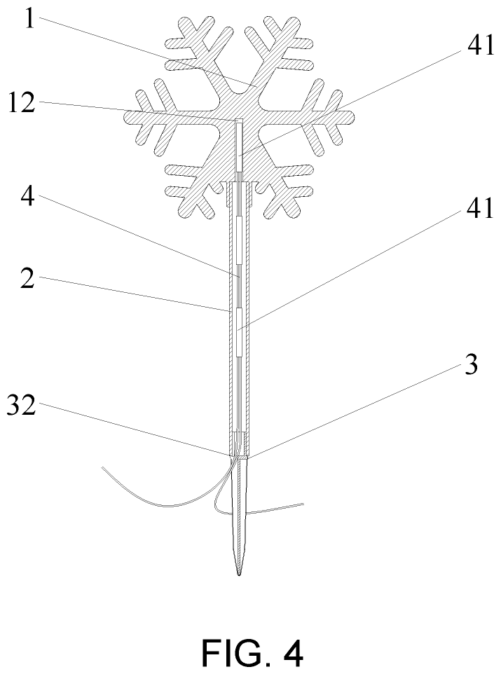

Preferably, as shown in the FIG. 4, the lamp pole 2 is made of the transparent material, and the LED lamp string 4 in the inner cavity of the lamp pole 2 includes at least one LED lamp bead 41. The LED lamp beads 41 in the lamp pole 2 form illumination, such that the overall light sensation effect is improved.

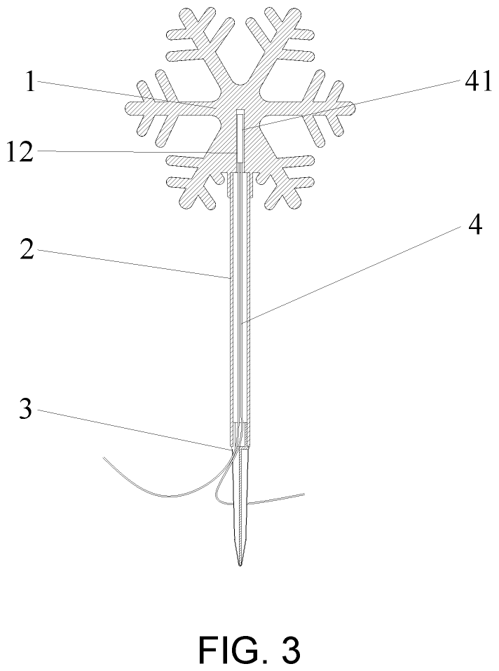

Preferably, as shown in the FIG. 3, the lamp pole 2 is made of a non-transparent material, and the LED lamp string 4 located in the inner cavity of the lamp pole 2 is the lamp string lead.

The present invention adopts the design of combining the lamp string with the ground insert through optimization design, to simplify the installation structure of the ground-inserted lamp, such that the ground-inserted decorative lamp string becomes smaller and more exquisite, has diverse forms, and is convenient for installation and use, thereby achieving lamplight decoration in a large region depending on requirements.

It can be known from the technical knowledge that the present invention can be implemented by other embodiments which are not separated from spiritual essence or necessary features of the present invention. Therefore, the above-disclosed embodiments are merely illustrative and not exclusive in all respects. All changes which are within the scope of the present invention or equivalent to the scope of the present invention are encompassed by the present invention.

1. A ground-inserted decorative lamp string, comprising at least two decorative lamp bodies, wherein each of the decorative lamp bodies comprises a decorative lamp main body and a ground insert; the decorative lamp main body comprises a decorative lampshade, a lamp pole and an LED lamp string; the decorative lampshade is internally provided with a lamp bead accommodating cavity, and the lamp bead accommodating cavity penetrates through an inner cavity of the lamp pole, an upper end of the lamp pole is configured to be cooperatively installed with the decorative lampshade and a lower end of the lamp pole is configured to be cooperatively installed with the ground insert, and the LED lamp string extends into the inner cavity of the lamp pole, such that at least one LED lamp bead extends through the upper end of the inner cavity of the lamp pole and is located in the lamp bead accommodating cavity,.
wherein a socket end is arranged in an upper portion of the ground insert, the socket end is configured to be inserted into the lower end of the lamp pole for fixation, and the socket end is provided with a lamp string slot extending in a direction along the ground insert, and an end portion of the LED lamp string is embeddedly mounted in the lamp string slot.

2. (canceled)

3. The ground-inserted decorative lamp string according to claim 1, wherein a number of the decorative lamp bodies is three or more, and adjacent two of the decorative light bodies are in electrical connection via a lamp string lead.

4. The ground-inserted decorative lamp string according to claim 3, further comprising a controller, wherein the controller is in conductive connection with adjacent one of the decorative lamp bodies via the lamp string lead.

5. The ground-inserted decorative lamp string according to claim 1, further comprising a solar power apparatus, wherein a clamping piece is arranged at one end of the solar power apparatus, and the clamping piece is able to be clamped on the lamp pole or the ground insert.

6. The ground-inserted decorative lamp string according to claim 1, wherein a joint of the lamp pole and the decorative lampshade is provided with an open slot, the open slot is provided with a decorative lamp string strip extending in a direction toward the ground insert, and the decorative lamp string strip is spirally coiled on an exterior of the lamp pole or floatingly circles the exterior of the lamp pole.

7. The ground-inserted decorative lamp string according to claim 3, wherein the decorative lampshade is made of a transparent material.

8. The ground-inserted decorative lamp string according to claim 7, wherein the decorative lampshade is in a shape of any one or more of snow, star, plant or animal.

9. The ground-inserted decorative lamp string according to claim 8, wherein the lamp pole is made of a transparent material, and the LED lamp string in the inner cavity of the lamp pole comprises the at least one LED lamp bead.

10. The ground-inserted decorative lamp string according to claim 8, wherein the lamp pole is made of a non-transparent material and the LED lamp string in the inner cavity of the lamp pole is the lamp string lead.
